(19) United States
(12) Patent Application Publication
(10) Pub. No.: US 2026/0260080 A1
(43) Pub. Date: Sep. 3, 2026

(54) REAL-TIME BI-DIRECTIONAL LANGUAGE TRANSLATION USING DUAL LANGUAGE MODELS IN CONFERENCE CALLS

(71) Applicant: Twilio Inc, San Francisco, CA (US)

(72) Inventors: Swastik Mishra, Bengaluru (IN); Savitri Kerakalamatti, Pune (IN); Neeraj Kumar Jha, Bengaluru (IN)

(21) Appl. No.: 19/194,268

(22) Filed: Apr. 30, 2025

(30) Foreign Application Priority Data
Feb. 28, 2025 (IN) 202511018104

(51) Int. Cl. G06F 40/58; G06F 3/0482; G06F 3/0484; G10L 13/047; G10L 15/183; G10L 15/30; G10L 25/78; H04M 3/56

(52) U.S. Cl. CPC G06F 40/58; G10L 13/047; G10L 15/183; G10L 15/30; G10L 25/78; H04M 3/568; G06F 3/0482; G06F 3/0484

(57) ABSTRACT

A technique for enabling real-time bi-directional language translation in voice communications using a conference call infrastructure and coordinated language translation sessions. The technique enables seamless communication between participants speaking different languages by integrating speech recognition, text-based language translation, and speech synthesis within a real-time bidirectional communication protocols architecture. The system employs a novel dual-session approach where separate translation pipelines process each language direction independently, coordinating the flow of voice data through speech-to-text conversion, large language model (LLM) translation, and text-to-speech synthesis. A sophisticated orchestration layer manages the real-time processing of voice streams, handles conversation interruptions, and maintains natural conversation flow between participants. Consistent with some embodiments, the system leverages existing voice infrastructure while adding specialized components for managing parallel translation processes, real-time bidirectional communication protocols, and integration with generative language models.

### TECHNICAL FIELD

The present application pertains to the technical field of real-time voice communication and language translation systems. More specifically, the innovations described herein relate to bi-directional language translation in conference call environments using real-time bidirectional communication protocols and generative language models, such as large language models (LLMs). Embodiments described herein provide for coordinating multiple translation sessions within a conference call infrastructure, enabling seamless communication between participants speaking different languages through automated speech recognition, text-based language translation, and speech synthesis, while maintaining natural conversation flow through sophisticated orchestration of voice streams and translation processes.

### BACKGROUND

Advancements in artificial intelligence (AI) and natural language processing (NLP) have revolutionized the way humans interact with technology. Over the past few decades, significant progress in computational power, algorithmic sophistication, and data availability has fueled the development of systems capable of understanding and generating human language with unprecedented accuracy.

The evolution of natural language processing began with rule-based systems that relied on handcrafted grammars and dictionaries to interpret text. While these systems demonstrated early promise, their performance was limited by rigid structures and a lack of adaptability to diverse linguistic contexts. The emergence of statistical methods and machine learning (ML) marked a paradigm shift, enabling systems to learn patterns from large datasets. Techniques such as hidden Markov models (HMMs) and support vector machines (SVMs) facilitated the development of basic language understanding applications, such as speech recognition and text classification.

In recent years, deep learning has propelled natural language processing into a new era. Neural network architectures, particularly recurrent neural networks (RNNs) and convolutional neural networks (CNNs), brought significant improvements in processing sequential data. However, the introduction of transformer-based architectures marked a defining moment in the evolution of NLP. Transformers, characterized by their ability to model long-range dependencies through attention mechanisms, became the foundation for the development of large language models (LLMs).

LLMs, such as OpenAI's GPT series, BERT, and similar frameworks, leverage massive amounts of data and sophisticated architectures to achieve a nuanced understanding of language. These models are pre-trained on diverse corpora and fine-tuned for specific tasks, enabling them to perform complex language-related functions such as text generation, translation, summarization, and sentiment analysis. Furthermore, advancements in hardware, including graphics processing units (GPUs) and tensor processing units (TPUs), have enabled the training of increasingly large models with billions of parameters, further enhancing their performance and capabilities.

### BRIEF DESCRIPTION OF THE DRAWINGS

Embodiments of the present invention are illustrated by way of example and not limitation in the figures of the accompanying drawings, in which:

FIG. 1 illustrates, in accordance with some embodiments, a cloud-based communication platform architecture integrating voice services, messaging services, and AI/machine learning capabilities with customizable business logic and third-party AI model service providers.

FIG. 2 illustrates, in accordance with some embodiments, a real-time language translation system for conference calls showing the interaction between translator bots, conference participants speaking different languages, and the communication platform components including voice service client, automatic speech recognition (ASR) model, text-to-speech (TTS) model, and third-party infrastructure.

FIG. 3 illustrates, in accordance with some embodiments, a configuration interface for setting up voice server parameters, ASR model selection, interruption controls, and text-to-speech options for the translation service.

FIG. 4 illustrates, in accordance with some embodiments, a mobile device interface allowing users to select their preferred speaking language before joining a translated conference call.

FIG. 5 illustrates, in accordance with some embodiments, a customer profile interface displaying participant information and language selection options for both parties before initiating a translated conference call.

FIG. 6 illustrates, in accordance with some embodiments, a flowchart showing steps for establishing and conducting a multi-language conference call with real-time translation capabilities.

FIG. 7 illustrates, in accordance with some embodiments, a software architecture diagram showing various application layers and components that support the translation service functionality.

FIG. 8 illustrates, in accordance with some embodiments, a machine architecture diagram showing the processing components, memory systems, and I/O interfaces that enable the real-time translation capabilities.

### DETAILED DESCRIPTION

Described herein are techniques for enabling real-time bi-directional language translation in voice communications using a conference call infrastructure and coordinated language translation sessions. The techniques enable seamless communication between participants speaking different languages by integrating speech recognition, text-based language translation, and speech synthesis within a real-time bidirectional communication protocols architecture. The system employs a novel dual-session approach where separate translation pipelines process each language direction independently, coordinating the flow of voice data through speech-to-text conversion, large language model (LLM) translation, and text-to-speech synthesis. A sophisticated orchestration layer manages the real-time processing of voice streams, handles conversation interruptions, and maintains natural conversation flow between participants. Consistent with some embodiments, the system leverages existing voice infrastructure while adding specialized components for managing parallel translation processes, real-time bidirectional communication protocols, and integration with generative language models. In the following description, numerous specific implementation details are provided to enable a thorough understanding of the various aspects and embodiments, including techniques for establishing translation sessions, methods for coordinating multiple language models, and approaches for managing real-time voice translation in conference environments. It will be apparent to one skilled in the art, however, that these techniques may be practiced in many different forms and that various modifications and alterations may be made without departing from the broader spirit and scope of the innovations described herein.

In the interconnected global economy of today, businesses face significant challenges in providing effective customer service and conducting sales operations across language barriers. As companies expand internationally, they encounter an increasing need to communicate with customers, partners, and stakeholders who speak different languages. This communication gap affects critical business operations, ranging from customer support calls to sales presentations, potentially limiting the ability of a company to enter and thrive in new markets.

Traditionally, organizations have addressed these challenges by employing human translators or multilingual agents to facilitate communication between parties speaking different languages. In a typical scenario, a three-way call would be established, involving the customer service agent, the customer, and a human translator. The translator would listen to each party and provide real-time interpretation of the conversation. While functional, this approach presents several significant drawbacks. It is operationally expensive, requiring the availability of human translators proficient in multiple language pairs. Additionally, it introduces delays in communication, as the translator must process and relay information between parties. This process often prolongs decision-making and extends conversation times, reducing overall efficiency.

Before the advent of LLMs, technological solutions sought to address these challenges through automated translation systems. These systems typically integrated rule-based or statistical machine translation techniques with basic speech recognition and text-to-speech capabilities. However, earlier technological approaches were marked by numerous limitations that hindered their effectiveness in real-world business scenarios.

One significant technical shortcoming of traditional systems was their limited language support. These solutions could only handle a fixed set of language pairs and required extensive programming to accommodate each new language combination. Additionally, the quality of translations was often poor. Early machine translation systems frequently produced literal, word-for-word translations that failed to capture nuances and contextual subtleties, resulting in misunderstandings.

Another critical issue was high latency. The sequential process of converting speech to text, translating it, and then synthesizing it back into speech created delays that disrupted the natural flow of conversations. Furthermore, these systems lacked the ability to understand natural language effectively. They struggled with interpreting context, idiomatic expressions, and conversational nuances, often producing technically accurate but contextually inappropriate translations.

The inflexibility of these systems also posed challenges. Built as monolithic architectures, traditional solutions were difficult to scale or adapt to diverse use cases. They could not easily manage real-time interruptions or maintain the dynamic flow of conversations required for effective communication in customer service and sales environments.

These limitations rendered earlier automated translation solutions inadequate for business contexts where fluid, natural communication is critical. As companies continued to expand globally, the need for a more sophisticated, real-time translation solution became increasingly apparent—one capable of delivering accuracy and maintaining natural conversation flow while remaining cost-effective and scalable.

To address the technical challenges inherent in real-time language translation, described in the preceding discussion of traditional human translators and early technological approaches, the innovations described herein leverage advanced voice processing capabilities and conference call infrastructure to enable seamless communication between participants speaking different languages. The innovative solution addresses the technical challenges of real-time language translation through a system architecture that leverages a voice service infrastructure and conference call capabilities. This voice service provides a programmable interface for processing real-time audio streams, enabling speech recognition, text processing, and speech synthesis through various real-time bidirectional communication protocols. Such protocols may include websockets for persistent full-duplex connections, HTTP/2 with server push capabilities for multiplexed streaming, gRPC for bidirectional streaming over HTTP/2, Server-Sent Events (SSE) for server-to-client streaming, or Message Queuing Telemetry Transport (MQTT) for lightweight messaging-each offering distinct advantages for managing real-time voice and text data streams between system components.

Consistent with some embodiments, the technique involves a novel dual-session approach that enables true bi-directional translation between participants speaking different languages. The system implements this capability through a conference call architecture where multiple participants, including the two human speakers and translation components, are connected simultaneously. Each translation direction is handled by a separate voice service session, with its own dedicated infrastructure instance and LLM.

The technical implementation begins when an end-customer initiates a call through the voice infrastructure. The system establishes a bi-directional websocket media connection and initiates two parallel voice processing sessions-one for each language direction. When a participant speaks, their audio is captured and processed through an Automatic Speech Recognition (ASR) component that converts it to text. This text is then relayed to the appropriate websocket server within the infrastructure of the customer.

A sophisticated orchestration layer manages the real-time processing flow, handling the complexities of natural conversation including interruptions and pauses. The system employs a token-based approach where text is processed and transmitted in smaller chunks, with each token marked as either continuing (last=false) or final (last=true). This granular control enables the system to handle natural conversation patterns, including the ability for participants to interrupt each other mid-sentence.

The solution addresses latency challenges through parallel processing and efficient websocket communication protocols. Rather than waiting for complete utterances, the system processes speech in smaller segments and begins translation as soon as meaningful chunks are available. This approach significantly reduces the delay between spoken words and their translated output, enabling more natural conversation flow.

The architecture provides flexibility through its modular design, allowing customers to deploy their own infrastructure components. The infrastructure of the customer can incorporate additional knowledge and memory systems to augment the translation capabilities of the LLM. This allows for domain-specific customization and improvement of translation quality based on context and specialized vocabulary.

The system handles the technical complexity of coordinating multiple components—including speech recognition, LLM translation, and text-to-speech synthesis—while maintaining synchronization between parallel translation sessions. This coordination is achieved through the voice service client, which manages the routing of audio and text streams between components and ensures proper sequencing of translated content. Other aspects and advantages of the various embodiments will be readily apparent from the detailed description of the several figures that follows.

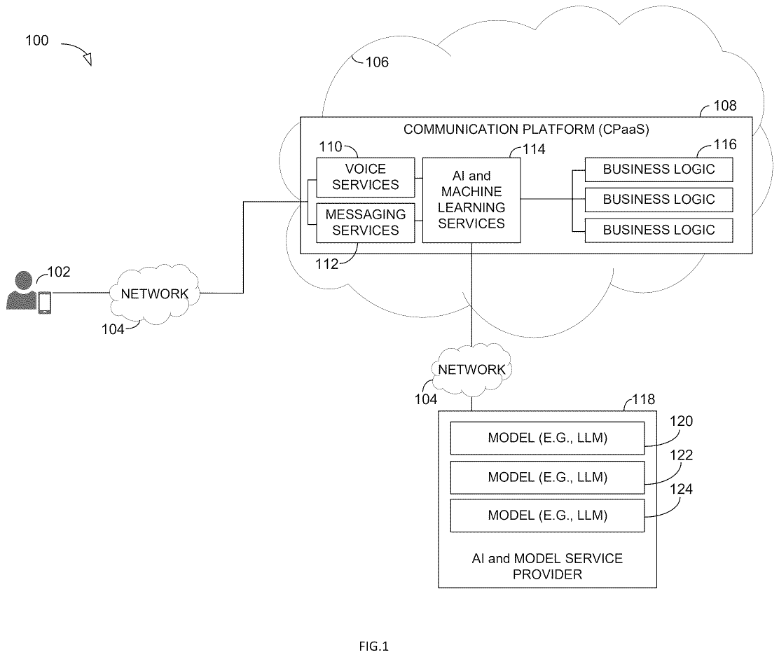

FIG. 1 illustrates, in accordance with some embodiments, a cloud-based communications platform 108 that integrates voice services 110 and messaging services 112 with AI and machine learning capabilities, wherein the platform 108 enables real-time language translation between users speaking different languages through configurable voice services and third-party AI model service providers 118.

Consistent with some embodiments, the communications platform 108 is implemented within a cloud computing environment 106 and provides customers with configurable translation services for implementing multilingual communication applications. The communications platform 108 includes voice services 110 for processing audio communications in different languages, messaging services 112 for handling text-based interactions, and AI and machine learning services 114 that can be configured according to customer-specific business logic 116 to enable real-time translation between languages.

The communications platform 108 enables business customers to develop and deploy customized translation applications that serve their individual end-users. For example, a business customer may configure the services of the communications platform 108 and provide business logic 116 to create a customized conference call application that handles real-time translation between participants speaking different languages. In this context, client device 102 represents an end-user device belonging to a conference participant, where the participant interacts with the customized application that incorporates language-specific ASR models and TTS engines via the specific business logic 116 of the business customer.

The business logic components 116 enable customers to define and implement their own translation workflows through the platform 108. For example, a customer may configure the business logic 116 to implement language-specific translation services that leverage the voice services 110 and AI capabilities 114 of the communications platform while interfacing with third-party language models hosted by an AI and model service provider 118, or hosted locally by the business customer.

In this example, the AI and model service provider 118 hosts multiple models 120, 122, 124 (e.g., large language models or LLMs) that can be accessed by customer applications through the AI and machine learning services 114 of the communications platform 108. This architecture enables customers to create sophisticated translation applications while maintaining control over language model selection and configuration through the integrated services of the communications platform 108.

A user device 102 communicates with the communications platform 108 over a network 104, which may include the Public Switched Telephone Network (PSTN), Voice over Internet Protocol (VoIP) networks, Session Initiation Protocol (SIP) networks, or other IP-based telecommunications networks. For PSTN connectivity, users can dial into provided phone numbers that are configured with the translation service through Communication Control Markup Language (CCML) applications. For IP-based communications, the platform supports WebSocket connections, WebRTC clients, and SIP endpoints that enable real-time bidirectional media streams.

The communications platform 108 coordinates the processing of these inputs through various telephony protocols and interfaces, including:
SIP trunking for enterprise VoIP integration
WebSocket secure (WSS) connections for real-time media streaming
RTP/SRTP protocols for encrypted media transport
CCML markup language for programmatic call control

The communications platform interfaces with appropriate AI models to generate translated responses while maintaining separate translation sessions for each language pair through dedicated WebSocket connections. For PSTN calls, the platform handles codec transcoding between traditional telephony formats (e.g., G.711) and digital formats suitable for AI processing. For IP-based calls, the platform can utilize native codecs while maintaining separate voice sessions for each language direction.

The communications platform 108 enables efficient processing of multilingual voice interactions by integrating the various services. Voice services 110 handle audio input/output in multiple languages, while messaging services 112 manage text-based communications. The AI and machine learning services 114 coordinate with the business logic 116 to apply appropriate language models and translation rules.

The network connections 104 facilitate real-time communication between the user devices 102, the communication platform 108, and the AI model service provider 118. These connections enable low-latency processing of voice inputs while maintaining separate translation sessions for each language pair. Through this architecture, the system 100 provides a comprehensive framework for real-time multilingual communication by coordinating cloud-based services, AI/ML capabilities, and multiple specialized translation models, all while maintaining efficient communication paths between components.

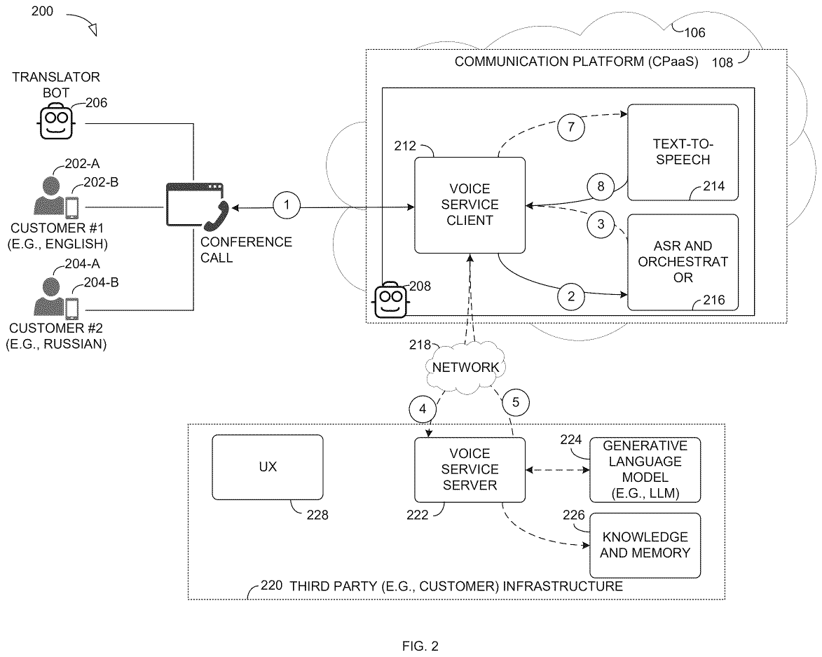

FIG. 2 illustrates a real-time language translation system 200 that enables multilingual conference calls between participants speaking different languages, consistent with some embodiments. The system 200 includes a first translator bot 206 and a second translator bot 208 that facilitate bidirectional communication between Customer #1 202-A, using a first device 202-B and speaking a first language (e.g., English) and Customer #2 204-A, using a second device 204-B and speaking a second language (e.g., Russian) through a conference call interface.

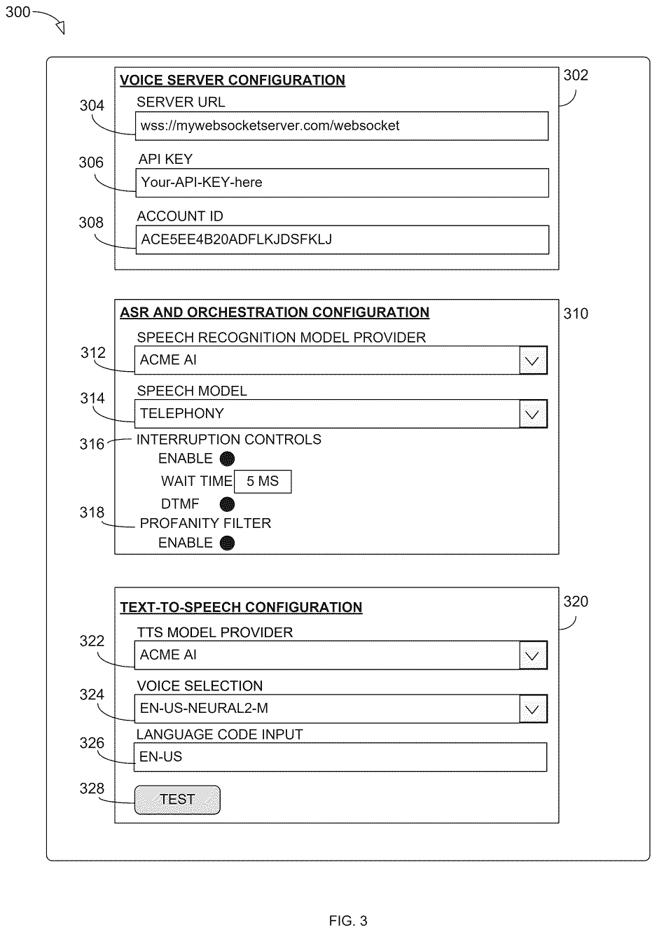

Prior to initiating the conference call, the system is pre-configured through the administrative interface (shown in FIG. 3) to specify the necessary components and parameters for each supported language pair. This includes configuring the voice server URL, API keys, and account credentials that enable access to the customer's infrastructure, as well as selecting appropriate ASR and TTS models optimized for each target language.

The pre-configuration also establishes the language-specific settings for each translator bot, including:
Speech recognition model providers and speech models for accurate transcription
Text-to-speech voice selections and language codes
Interruption controls and wait times to manage conversation flow
Integration parameters for the customer's LLM infrastructure and knowledge base

When participants join the conference call, the system automatically initiates the appropriate translator bots based on several possible identification methods:
Client software configuration specifying the user's preferred language
Phone numbers pre-configured for specific languages
User IDs or profiles with associated language preferences
Interactive voice response (IVR) language selection
Web interface language selection

Each translator bot (206, 208) establishes a separate communication session configured for translating between a specific language pair. In this example, the first translator bot 206 handles English-to-Russian translation while the second translator bot 208 handles Russian-to-English translation, with each bot maintaining its own dedicated websocket connection and translation pipeline. The websocket connections are established using configurable server URLs, API keys, and account credentials specified through a voice server configuration interface.

For example, when Customer #1 connects using a client configured for English, the system initiates translator bot 206 with English ASR and Russian TTS capabilities. Similarly, when Customer #2 connects using a Russian-configured phone number, translator bot 208 is initiated with Russian ASR and English TTS capabilities. This automated bot initialization ensures that appropriate translation services are immediately available when participants join the conference.

The communication platform 108 coordinates the translation services through multiple components. When Customer #1 speaks in English, their audio is routed through path 1 to the voice service client 212, which forwards it to the ASR and orchestrator 216 configured for English speech recognition via path 2. The recognized English text is returned via path 3 and transmitted to the customer's infrastructure through path 4. The ASR and orchestrator can be configured with customizable interruption controls, wait times, and profanity filtering options to optimize the conversation flow.

Similarly, when Customer #2 speaks in Russian, their audio follows the same pathway but through the second translator bot 208, which utilizes an ASR model specifically configured for Russian speech recognition. Each bot maintains separate translation sessions to ensure accurate language processing in both directions. The system supports configurable buffering and chunking of audio segments to minimize latency while maintaining translation quality.

Within the customer's third-party infrastructure 220, the voice service server 222 processes the received text using the configured generative language model 224, which can be selected and optimized for specific language pairs. The knowledge and memory system 226 augments translations with contextual information and can be integrated with customer-specific data sources to improve translation accuracy. The UX interface 228 enables configuration and monitoring of both translation pipelines, including real-time latency metrics and usage analytics.

While FIG. 2 shows the generative language model 224 as being integrated within the customer's third-party infrastructure 220, in some embodiments, the generative language model 224 may instead be hosted by an external AI and model service provider 118, similar to the model service provider shown in FIG. 1. In such embodiments, the voice service server 222 interfaces with the external AI provider's models (120, 122, 124) through appropriate APIs and authentication mechanisms to perform the language translations.

The flexibility to use either customer-hosted or third-party hosted language models enables businesses to select the most appropriate translation solution for their needs. When using external AI providers, the voice service server 222 can be configured with the necessary API keys, model selection parameters, and routing logic to seamlessly integrate with multiple AI service providers while maintaining the benefits of the knowledge and memory system 226 for contextual augmentation.

The translated text is returned via path 5 to the respective translator bot, where the text-to-speech component 214 converts it into synthesized speech in the target language (paths 7-8). For English-to-Russian translation, bot 206 delivers Russian audio to Customer #2, while for Russian-to-English translation, bot 208 delivers English audio to Customer #1. The text-to-speech configuration allows selection of specific voice models and language codes for each target language.

The system maintains separate translation sessions for each language direction, enabling real-time bidirectional translation while managing latency through configurable buffering and chunking of audio segments. Each translator bot coordinates with the voice service client 212 to handle speech interruptions and ensure proper synchronization of the translation streams.

In some embodiments, the system includes a welcome greeting configuration that can be customized for each language and played when participants join the conference call. The greeting can be configured to be interruptible or non-interruptible based on customer preferences.

The system also supports DTMF detection and handling, allowing participants to use keypad inputs during the call. These inputs can trigger specific actions or responses configured through the customer's infrastructure.

For monitoring and troubleshooting purposes, the system generates detailed telemetry data including latency metrics for each component (ASR, TTS, LLM), tracks usage data associated with customer accounts, and maintains logs of translation sessions. This data can be accessed through the UX interface to optimize system performance and identify potential issues.

FIG. 3 illustrates an administrative interface 300 that enables business customers to configure various aspects of the real-time translation system, consistent with some embodiments. The user interface 300 includes three main configuration sections: voice server configuration 302, ASR and orchestration configuration 310, and text-to-speech configuration 320. However, the user interface 300 of FIG. 3 is intended as an example, and in various embodiments, additional configuration parameters may be presented to allow for customizing the translation service to meet the needs of the business customer.

The voice server configuration section 302 allows business customers to specify connection parameters including a websocket server URL 304 for establishing secure connections, an API key 306 for authentication, and an account ID 308 for tracking usage. These parameters enable the system to securely route translation requests between the communication platform and the customer's infrastructure.

The ASR and orchestration configuration section 310 provides granular control over speech recognition capabilities. A dropdown menu 312 enables selection of the speech recognition model provider, while another dropdown 314 allows specification of the speech model type (e.g., telephony). The interface includes interruption controls 316 that can be enabled or disabled, with configurable wait times to optimize conversation flow. Additional options include DTMF detection 318 for handling keypad inputs and profanity filtering capabilities.

The text-to-speech configuration section 320 enables customization of speech synthesis parameters. Customers can select their preferred TTS model provider 322 and specific voice selection 324 (e.g., EN-US-NEURAL2-M) for each language. The language code input field 326 specifies the target language for speech synthesis, while a test button 328 allows administrators to verify the configured settings by playing sample translated audio using the selected TTS model and voice parameters, enabling them to evaluate and adjust the voice characteristics before deploying to production.

The system supports both PSTN and digital client connections for conference participants. When using PSTN, participants can dial into a provided phone number that is configured with the translation service. The CCML application associated with the number can be programmed to automatically connect callers to the appropriate translator bot based on their selected language pair.

For selecting language pairs, the system provides a flexible configuration interface where customers can specify both source and target languages for each translator bot. Multiple language pairs can be configured simultaneously, allowing the system to support various combinations of languages in a single conference call. Each language pair requires its own vox ray session with appropriate ASR and TTS models configured for the specific languages.

The configuration settings directly impact system behavior in several ways. The interruption controls and wait times affect how the system handles overlapping speech and conversation flow. The speech recognition model selection influences accuracy for specific language inputs, while voice selection affects the naturalness of synthesized speech output. The websocket URL and API key settings determine how the system interfaces with the customer's translation infrastructure and language models.

The interface also enables configuration of welcome greetings in multiple languages, DTMF handling for interactive features, and profanity filtering to maintain appropriate conversation standards. These settings can be adjusted independently for each language pair and translation direction, providing granular control over the user experience.

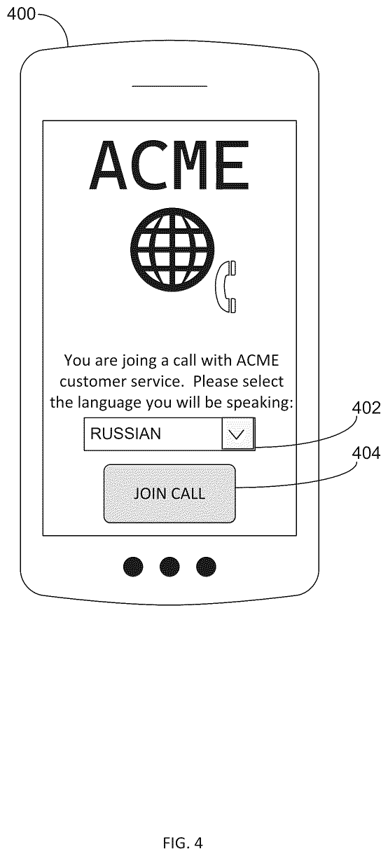

FIG. 4 illustrates a simplified user interface 400 that enables participants to easily join a translated conference call, consistent with some embodiments. The interface includes a language selection dropdown menu 402 where users can select their preferred speaking language, and a “JOIN CALL” button 404 that initiates the conference call connection.

The interface advantageously simplifies the user experience by requiring only two actions from the participant—selecting their speaking language and joining the call. When a user selects their language from dropdown menu 402, the system automatically configures the appropriate translator bot with language-specific ASR and TTS models optimized for that language.

Upon pressing the “JOIN CALL” button 404, the system establishes a conference call connection and initializes a dedicated voice session configured for the selected language. The session handles all translation processing transparently, allowing the user to simply speak in their chosen language without any additional configuration or technical knowledge required.

The interface may be accessed through various channels, including mobile applications, web browsers, or PSTN phone systems. For PSTN users, an interactive voice response (IVR) system can provide similar language selection capabilities through voice prompts or keypad inputs.

This streamlined approach enables real-time translation services while abstracting away the underlying complexity of multiple ASR models, TTS engines, and language model configurations. Users can focus on their conversation while the system automatically manages the translation pipeline, interruption handling, and audio synchronization between participants.

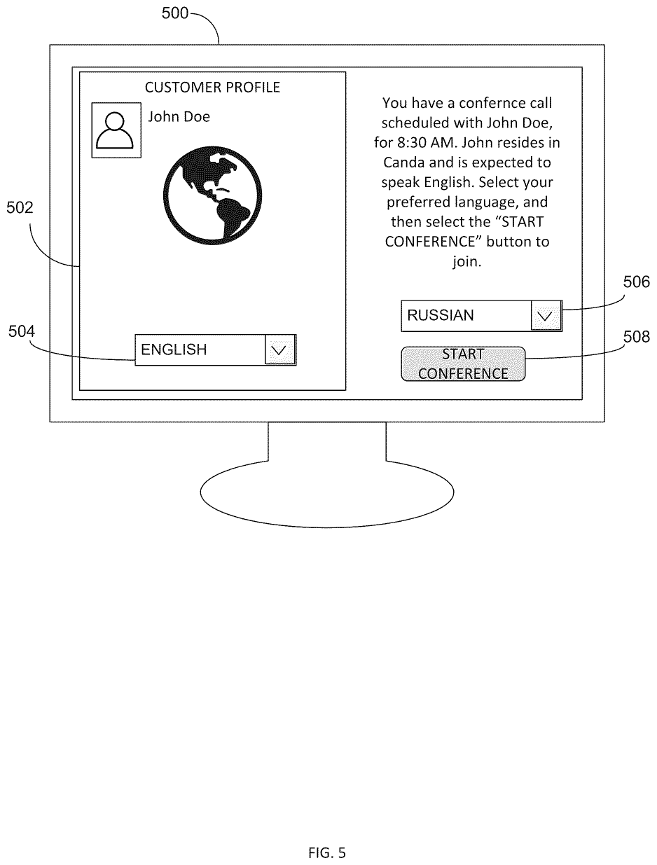

FIG. 5 illustrates a customer profile interface 500 that enables customer service agents to efficiently initiate translated conference calls, consistent with some embodiments. The interface 500 displays a customer profile section 502 showing basic information about the scheduled participant, including their name, location, and expected speaking language.

The interface advantageously leverages stored customer profile data to automatically configure appropriate language settings. In the example shown, the profile indicates that John Doe resides in Canada and is expected to speak English, which is reflected in the pre-selected English language option 504. This automatic language selection streamlines the call setup process while still allowing manual override if needed.

The interface 500 provides language selection dropdowns for both participants one showing the customer's language 504 (English) and another 506 allowing the agent to select their preferred speaking language (Russian). This dual-language configuration enables the system to automatically initialize the appropriate translator bots and language models when the conference begins.

When the agent clicks the “START CONFERENCE” button 508, the system establishes a conference call session and initializes two translator bots-one configured for English-to-Russian translation and another for Russian-to-English translation. Each bot maintains its own dedicated websocket connection and translation pipeline optimized for the selected language pair.

The interface displays relevant scheduling information, such as the conference call time (8:30 AM) and the customer's location (Canada), providing important context to the agent. This information helps ensure appropriate language selection and translation configuration before the call begins.

The system maintains the customer's language preference as part of their stored profile, which can be automatically applied to future interactions. However, the interface allows agents to override these defaults when necessary, providing flexibility while maintaining efficiency through intelligent defaults based on customer data.

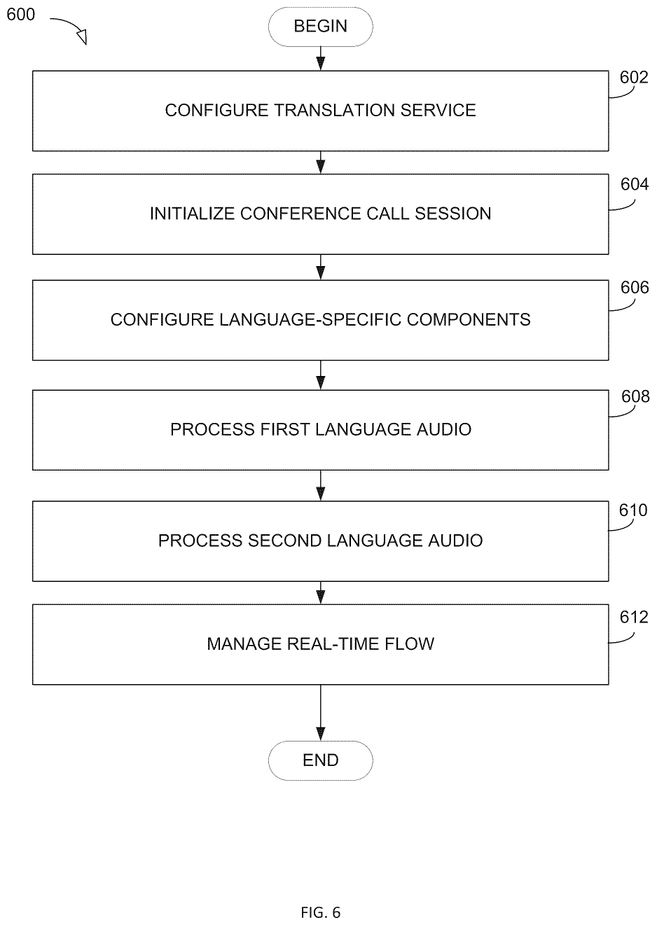

FIG. 6 illustrates a flowchart 600 showing method operations for providing real-time language translation in a conference call environment, consistent with some embodiments. The method begins with operation 602 for configuring the translation service.

During operation 602, the system receives configuration data through a voice server configuration interface that specifies connection parameters including server URLs, API keys, and account credentials for establishing secure connections with the customer's infrastructure. The configuration data also includes selections for ASR and TTS model providers, speech model types, interruption controls with configurable wait times and sensitivity thresholds, DTMF detection settings, and profanity filtering options for each supported language pair.

At operation 604, the method initializes a conference call session between participant devices. This operation includes establishing bidirectional communication connections for each translator bot using the configuration data from operation 602, and adding the translator bots as participants in the conference call. The system supports both PSTN and IP-based connections through WebSocket, SIP, and RTP/SRTP protocols, allowing participants to join via phone numbers or digital clients.

The method proceeds to operation 606 where language-specific components are configured. This includes configuring the first translator bot with an ASR model for the first language and TTS model for the second language, and configuring the second translator bot with an ASR model for the second language and TTS model for the first language. Each bot maintains separate processing pipelines optimized for its specific language pair, with models selected from supported providers through the configuration interface.

At operation 608, the method processes first language audio content. When a participant speaks in the first language, their audio is routed through the first translator bot to its configured ASR model to generate text content. This text is transmitted via the communication connection to the customer's infrastructure where it is processed by a generative language model configured with translation rules, conversation style parameters, and domain-specific context. The translated text is then converted to audio in the second language using the TTS model and transmitted to the other participant.

Similarly, at operation 610, the method processes second language audio content through the second translator bot following the same pattern but in the opposite direction. The customer's infrastructure augments translations using knowledge and memory systems that provide contextual information, conversation history, and domain-specific data sources.

At operation 612, the method manages real-time conversation flow. The voice service client monitors voice activity to detect speech pauses, handles overlapping speech through the configured interruption controls, buffers and chunks audio segments to optimize processing, and coordinates timing between ASR processing and TTS playback. This orchestration maintains natural conversation flow while ensuring accurate translations through:
Waiting for configurable pause durations before initiating speech recognition
Processing speech in smaller segments when interruptions are detected
Synchronizing delivery of translated audio between participants

Throughout these operations, the system maintains separate translation sessions for each language direction while coordinating through the conference call infrastructure. The customer's infrastructure processes translations using generative language models that can be hosted locally or accessed through external AI service providers, with all communication flowing through secure, authenticated connections established during the initial configuration.

The innovations described herein provide several significant advantages over traditional translation approaches. By employing a dual-session architecture with separate translation pipelines for each language direction, the system enables true bidirectional real-time communication while maintaining conversation quality and flow. This approach significantly reduces the operational costs and complexities associated with human translators while providing comparable or superior translation accuracy.

The system's sophisticated orchestration layer provides unique advantages in managing real-time conversation dynamics. By monitoring voice activity, handling interruptions through configurable controls, and synchronizing translation timing, the system maintains natural conversation flow that closely mimics direct human interaction. The ability to process speech in smaller segments and begin translation before complete utterances enables significantly reduced latency compared to traditional batch translation approaches.

The modular architecture provides exceptional flexibility and scalability advantages. Business customers can leverage existing voice infrastructure while customizing translation services through configurable ASR and TTS models, interruption controls, and language-specific processing parameters. The ability to integrate with either customer-hosted or third-party AI models enables businesses to select optimal translation solutions while maintaining control over language processing.

The system's knowledge and memory integration capabilities provide superior translation accuracy through contextual augmentation. By incorporating customer-specific information, conversation history, and domain-specific terminology, the system delivers more accurate and contextually appropriate translations compared to generic translation services. This is particularly valuable in specialized business contexts like customer service and sales.

The solution's comprehensive configuration interfaces and monitoring capabilities enable efficient deployment and optimization. Through detailed telemetry data, usage analytics, and session logging, businesses can continuously monitor translation quality and system performance while making necessary adjustments to improve user experience. The ability to test configurations before deployment ensures optimal translation quality and voice characteristics for each language pair.

### Software Architecture

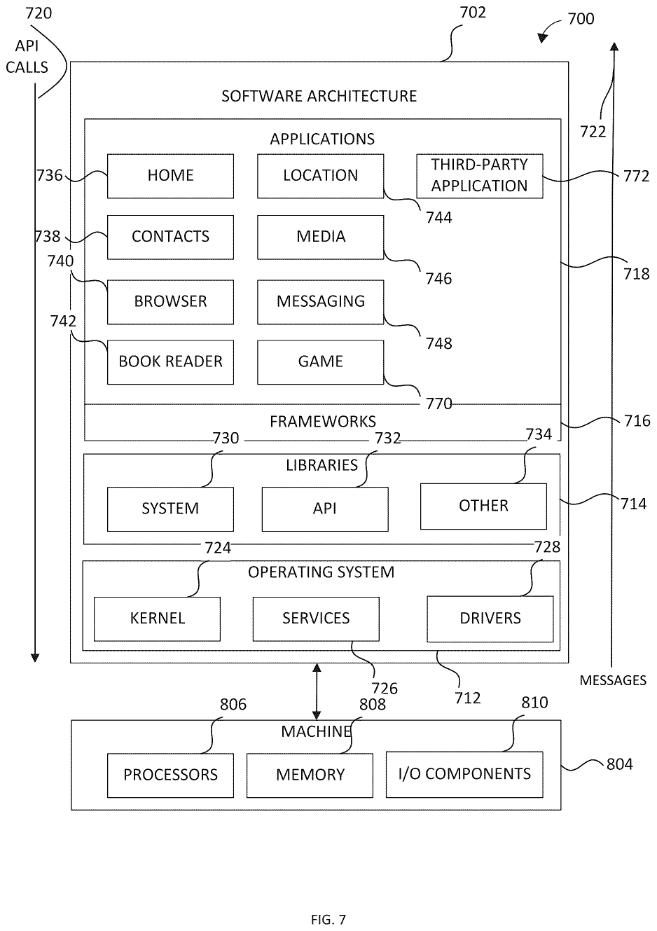

FIG. 7 is a block diagram 700 illustrating a software architecture 702, which can be installed on any one or more of the devices described herein. The software architecture 702 is supported by hardware such as a machine 804 that includes processors 806, memory 808, and I/O components 810. In this example, the software architecture 702 can be conceptualized as a stack of layers, where each layer provides a particular functionality. The software architecture 702 includes layers such as an operating system 712, libraries 714, frameworks 716, and applications 718. Operationally, the applications 718 invoke API calls 720 through the software stack and receive messages 722 in response to the API calls 720.

The operating system 712 manages hardware resources and provides common services. The operating system 712 includes, for example, a kernel 724, services 726, and drivers 728. The kernel 724 acts as an abstraction layer between the hardware and the other software layers. For example, the kernel 724 provides memory management, processor management (e.g., scheduling), component management, networking, and security settings, among other functionalities. The services 726 can provide other common services for the other software layers. The drivers 728 are responsible for controlling or interfacing with the underlying hardware. For instance, the drivers 728 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 714 provide a common low-level infrastructure used by the applications 718. The libraries 714 can include system libraries 730 (e.g., C standard library) that provide functions such as memory allocation functions, string manipulation functions, mathematical functions, and the like. In addition, the libraries 714 can include API libraries 732 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 714 can also include a wide variety of other libraries 734 to provide many other APIs to the applications 718.

The frameworks 716 provide a common high-level infrastructure that is used by the applications 718. For example, the frameworks 716 provide various graphical user interface (GUI) functions, high-level resource management, and high-level location services. The frameworks 716 can provide a broad spectrum of other APIs that can be used by the applications 718, some of which may be specific to a particular operating system or platform.

In an example, the applications 718 may include a home application 736, a contacts application 738, a browser application 740, a book reader application 742, a location application 744, a media application 746, a messaging application 748, a game application 750, and a broad assortment of other applications such as a third-party application 752. The applications 718 are programs that execute functions defined in the programs. Various programming languages can be employed to create one or more of the applications 718, structured in a variety of manners, such as object-oriented programming languages (e.g., Objective-C, Java, or C++) or procedural programming languages (e.g., C or assembly language). In a specific example, the third-party application 752 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 752 can invoke the API calls 720 provided by the operating system 712 to facilitate functionalities described herein.

### Machine Architecture

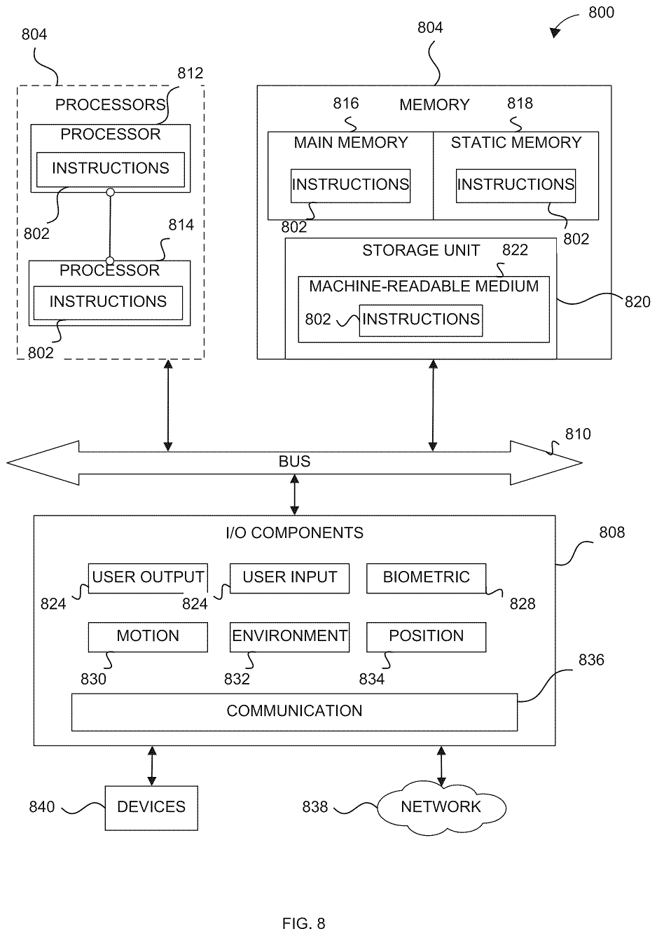

FIG. 8 is a diagrammatic representation of the machine 800 within which instructions 802 (e.g., software, a program, an application, an applet, an app, or other executable code) for causing the machine 800 to perform any one or more of the methodologies discussed herein may be executed. For example, the instructions 802 may cause the machine 800 to execute any one or more of the methods described herein. The instructions 802 transform the general, non-programmed machine 800 into a particular machine 800 programmed to carry out the described and illustrated functions in the manner described. The machine 800 may operate as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 802, sequentially or otherwise, that specify actions to be taken by the machine 800. Further, while a single machine 800 is illustrated, the term machine” shall also be taken to include a collection of machines that individually or jointly execute the instructions 802 to perform any one or more of the methodologies discussed herein. The machine 800, for example, may comprise the user device or any one of multiple server devices forming part of a server system. In some examples, the machine 800 may also comprise both client and server systems, with certain operations of a particular method or algorithm being performed on the server-side and with certain operations of the method or algorithm being performed on the client-side.

The machine 800 may include processors 804, memory 804, and input/output I/O components 808, which may be configured to communicate with each other via a bus 810.

The memory 806 includes a main memory 816, a static memory 818, and a storage unit 820, both accessible to the processors 804 via the bus 810. The main memory 806, the static memory 818, and storage unit 820 store the instructions 802 embodying any one or more of the methodologies or functions described herein. The instructions 802 may also reside, completely or partially, within the main memory 816, within the static memory 818, within machine-readable medium 822 within the storage unit 820, within at least one of the processors 804 (e.g., within the processor's cache memory), or any suitable combination thereof, during execution thereof by the machine 800.

The I/O components 808 may include a wide variety of components to receive input, provide output, produce output, transmit information, exchange information, capture measurements, and so on. The specific I/O components 808 that are included in a particular machine will depend on the type of machine. For example, portable machines such as mobile phones may include a touch input device or other such input mechanisms, while a headless server machine will likely not include such a touch input device. It will be appreciated that the I/O components 808 may include many other components that are not shown in FIG. 8. In various examples, the I/O components 808 may include user output components 624 and user input components 826. The user output components 824 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 826 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

The motion components 830 include acceleration sensor components (e.g., accelerometer), gravitation sensor components, rotation sensor components (e.g., gyroscope).

The environmental components 832 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

Communication may be implemented using a wide variety of technologies. The I/O components 608 further include communication components 636 operable to couple the machine 600 to a network 638 or devices 640 via respective coupling or connections. For example, the communication components 636 may include a network interface component or another suitable device to interface with the network 638. In further examples, the communication components 636 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 640 may be another machine or any of a wide variety of peripheral devices (e.g., a peripheral device coupled via a USB).

Moreover, the communication components 836 may detect identifiers or include components operable to detect identifiers. For example, the communication components 836 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 836, such as location via Internet Protocol (IP) geolocation, location via Wi-Fi® signal triangulation, location via detecting an NFC beacon signal that may indicate a particular location, and so forth.

The various memories (e.g., main memory 816, static memory 818, and memory of the processors 804) and storage unit 820 may store one or more sets of instructions and data structures (e.g., software) embodying or used by any one or more of the methodologies or functions described herein. These instructions (e.g., the instructions 802), when executed by processors 804, cause various operations to implement the disclosed examples.

The instructions 802 may be transmitted or received over the network 838, using a transmission medium, via a network interface device (e.g., a network interface component included in the communication components 836) and using any one of several well-known transfer protocols (e.g., hypertext transfer protocol (HTTP)). Similarly, the instructions 602 may be transmitted or received using a transmission medium via a coupling (e.g., a peer-to-peer coupling) to the devices 840.

What is claimed, is:

1. A method for providing real-time language translation in a conference call, the method comprising:
establishing a conference call session between a first participant device and a second participant device;
initializing a first translator bot and a second translator bot, wherein each translator bot establishes a bidirectional communication connection with a voice service client using configuration data received from a configuration interface, and each translator bot is added as a participant to the conference call session;
configuring the first translator bot with a first automatic speech recognition (ASR) model for the first language and first text-to-speech (TTS) model for the second language, and configuring the second translator bot with a second ASR model for the second language and second TTS model for the first language;
receiving, at the voice service client, first audio content from the first participant device, the first audio content in the first language;
routing, by the first translator bot, the first audio content to the first ASR model to generate first text content in the first language;
transmitting the first text content via the bidirectional communication connection to a customer-provided server infrastructure for translation;
receiving first translated text from the customer-provided server infrastructure via the bidirectional communication connection;
converting, via the first TTS model, the first translated text to first translated audio in the second language; and
transmitting the first translated audio to the second participant device through the conference call session.

2. The method of claim 1, further comprising:
receiving, at the voice service client, second audio content from the second participant device, the second audio content in the second language;
routing, by the second translator bot, the second audio content to the second ASR model to generate second text content in the second language;
transmitting the second text content via the bidirectional communication connection of the second translator bot to the customer-provided server infrastructure for translation;
receiving second translated text from the customer-provided server infrastructure via the bidirectional communication connection;
converting, via the second TTS model, the second translated text to second translated audio in the first language; and
transmitting the second translated audio to the first participant device through the conference call session.

3. The method of claim 1, wherein the configuration data comprises:
a voice server URL for establishing the bidirectional communication connection with the customer-provided server infrastructure;
an API key for authentication; and
an account ID for tracking usage.

4. The method of claim 3, wherein the configuration data further comprises:
interruption control settings including configurable wait times and sensitivity thresholds; and
DTMF detection and profanity filter settings.

5. The method of claim 1, wherein configuring the first and second translator bots comprises:
configuring each translator bot to use an ASR model from one of a plurality of ASR model providers selected through the configuration interface, wherein the configuration interface presents a plurality of available ASR model providers and speech model types for each language.

6. The method of claim 1, wherein configuring the first and second translator bots comprises:
configuring each translator bot to use a text-to-speech model from one of a plurality of text-to-speech model providers selected through the configuration interface, wherein the configuration interface presents a plurality of available text-to-speech model providers and voice characteristics for each language.

7. The method of claim 1, wherein configuring the first and second translator bots comprises:
specifying, through the configuration interface, language codes that define language-specific processing parameters for both the selected ASR and TTS models for each language pair;
storing the language codes along with the selected ASR and TTS models as configuration data in a format used to initialize the translator bots;
configuring welcome greetings to be played in each respective language when the conference call is established; and
specifying whether speech interruption is allowed during playback of the welcome greetings.

8. The method of claim 1, wherein the voice service client is configured to:
detect when speech has paused before initiating text conversion by monitoring voice activity in the received audio content;
manage overlapping speech through configurable interruption controls that include wait times and sensitivity thresholds specified in the configuration data;
buffer and chunk audio segments based on detected voice activity to optimize real-time processing of the audio content;
coordinate timing between ASR processing and TTS playback by:
waiting for configurable pause durations before initiating speech recognition,
processing speech in smaller segments when interruptions are detected, and
synchronizing delivery of translated audio to maintain natural conversation flow.

9. The method of claim 1, wherein the first participant device comprises a mobile application that:
displays a language selection interface allowing selection of the first language from a plurality of supported languages;
displays a button that, when activated, initiates connection to the conference call session; and
automatically configures the first translator bot based on the selected first language.

10. The method of claim 1, wherein the second participant device comprises a customer service interface that displays a customer profile including expected language preferences based on stored customer data;
presents language selection options for both the first and second languages;
displays scheduling and contextual information about the conference call; and
includes a button that initiates the conference call session with the configured translator bots.

11. The method of claim 1, wherein establishing the conference call session comprises:
receiving a phone number dial-in from a PSTN connection;
receiving a WebSocket connection from an IP-based client;
establishing SIP trunking for enterprise VoIP integration; and
coordinating RTP/SRTP protocols for encrypted media transport.

12. The method of claim 1, wherein the voice service client is configured to:
establish separate voice sessions for each language pair;
manage codec transcoding between telephony and digital formats;
coordinate multiple websocket connections for parallel translation streams; and
synchronize audio delivery timing across translation sessions.

13. The method of claim 1, wherein the customer-provided server infrastructure performs operations comprising:
receiving the first text content at a voice service server;
processing the first text content using a generative language model configured with a system prompt that defines:
translation rules for the specific language pair,
conversation style parameters including formality and tone, and
domain-specific terminology and context;
augmenting the translation using a knowledge and memory system that provides:
customer-specific contextual information,
previous conversation history, and
domain-specific data sources; and
returning the translated text via the bidirectional communication connection to the voice service client.

14. The method of claim 1, wherein the bidirectional communication connection comprises one of:
a websocket connection for real-time media streaming;
a Session Initiation Protocol (SIP) connection for enterprise VoIP integration;
an RTP/SRTP connection for encrypted media transport; or
an HTTP/2 connection with server push capabilities for multiplexed streaming.

15. A system for providing real-time language translation in a conference call environment, the system comprising:
at least one processor; and
at least one memory storage device storing instructions thereon, which, when executed by the at least one processor, cause the system to:
establish a conference call session between a first participant device and a second participant device;
initialize a first translator bot and a second translator bot, wherein each translator bot establishes a bidirectional communication connection with a voice service client using configuration data received from a voice server configuration interface, and each translator bot is added as a participant to the conference call session;
configure the first translator bot with a first ASR model for the first language and first TTS model for the second language, and configure the second translator bot with a second ASR model for the second language and second TTS model for the first language;
receive, at the voice service client, first audio content from the first participant device in the first language;
route the first audio content to the first ASR model to generate first text content;
transmit the first text content via the communication connection to a customer-provided server infrastructure;
receive first translated text from the customer-provided server infrastructure;
convert the first translated text to first translated audio using the first TTS model; and
transmit the first translated audio to the second participant device.

16. The system of claim 15, wherein the instructions further cause the system to:
receive second audio content from the second participant device in the second language;
route the second audio content to the second ASR model to generate second text content;
transmit the second text content to the customer-provided server infrastructure;
receive second translated text from the customer-provided server infrastructure;
convert the second translated text to second translated audio using the second TTS model; and
transmit the second translated audio to the first participant device.

17. The system of claim 15, wherein the instructions further cause the system to:
present a language selection interface on the first participant device;
receive a language selection through the interface;
establish the conference call connection; and
automatically configure the first translator bot based on the selected language.

18. The system of claim 15, wherein the instructions further cause the system to:
present on a display:
a customer profile including expected language preferences,
language selection options for both languages, and
scheduling information for the conference call;
receive language selections;
initialize the translator bots with the selected languages; and
establish the conference call session.

19. The system of claim 15, wherein the instructions further cause the system to:
establish separate voice sessions for each language pair;
manage codec transcoding between formats;
coordinate multiple communication connections;
synchronize audio delivery timing;
handle text-based communications; and
manage translation session state.

20. A non-transitory computer-readable medium storing instructions that, when executed by at least one processor, cause the processor to perform operations comprising:
establishing a conference call session between a first participant device and a second participant device;
initializing a first translator bot and a second translator bot, wherein each translator bot establishes a bidirectional communication connection with a voice service client using configuration data received from a configuration interface, and each translator bot is added as a participant to the conference call session;
configuring the first translator bot with a first automatic speech recognition (ASR) model for a first language and first text-to-speech (TTS) model for the second language, and configuring the second translator bot with a second ASR model for the second language and second TTS model for the first language;
receiving, at the voice service client, first audio content from the first participant device, the first audio content in the first language;
routing, by the first translator bot, the first audio content to the first ASR model to generate first text content in the first language;
transmitting the first text content via the bidirectional communication connection to a customer-provided server infrastructure for translation;
receiving first translated text from the customer-provided server infrastructure via the bidirectional communication connection;
converting, via the first TTS model, the first translated text to first translated audio in the second language; and
transmitting the first translated audio to the second participant device through the conference call session.
